(19) United States
(12) Patent Application Publication
(10) Pub. No.: US 2015/0329290 A1
(43) Pub. Date: Nov. 19, 2015

(54) SYSTEM FOR TRANSPORTING AWAY STACKS OF ITEMS WHICH CONSIST OF PALLETS WITH ITEMS STACKED THEREON, AND METHOD FOR TRANSPORTING AWAY STACKS OF ITEMS WHICH CONSIST OF PALLETS WITH ITEMS STACKED THEREON

(71) Applicant: MSK- Verpackungs-Systeme GmbH, Kleve (DE)

(72) Inventors: Reiner HANNEN, Kalkar-Wissel (DE); Frank MICHELS, Kleve (DE)

(21) Appl. No.: 14/711,023

(22) Filed: May 13, 2015

(30) Foreign Application Priority Data
May 15, 2014 (DE) 202014102298.8

(51) Int. Cl. B65G 15/00; B66C 1/22; B65G 47/52; B65G 29/00; B65G 47/244

(52) U.S. Cl. CPC B65G 15/00; B65G 29/00; B65G 47/244; B65G 47/52; B66C 1/22; B65G 2201/0267; B65G 2203/0283; B65G 2207/14; B65G 2811/0626; B65G 2812/02128; B65G 2812/14

(57) ABSTRACT

A system for transporting pallets with stacked items, such as paper or cardboard, comprises at least two supply lines, which run in a transport direction and the end regions are laterally next to each other. Each group of stacks has at least two stacks arranged next to one another transversely with respect to the transport direction. The pallets are a small distance from one another. A transport device is provided which is movable laterally to the end regions for taking delivery of the entire group from said supply line. A transfer station comprises supply, hoisting and removal devices. The transport device is movable laterally for transferring the entire group to the supply device. The hoisting device transfers either a stack of items of one group or simultaneously a plurality of stacks of items from the supply device to the removal device. The removal device comprises two independently drivable conveyor belts.

### CROSS-REFERENCE TO RELATED APPLICATIONS AND CLAIM TO PRIORITY

This application is related to application number 20 2014 102 298.8, filed May 15, 2014 in the Federal Republic of Germany, the disclosure of which is incorporated herein by reference and to which priority is claimed.

### FIELD OF THE INVENTION

The invention relates to a system for transporting away stacks of items which consist of pallets with items stacked thereon, in particular with stacks of paper or cardboard stacked thereon, wherein the system comprises at least two supply lines for the stacks of items, which are designed so as to run in a transport direction and the end regions of which are arranged laterally next to each other, and wherein each supply line, as seen in the transport direction, ends with groups of stacks of items, wherein each group consists of at least two stacks of items which are arranged next to one another in the end region transversely with respect to the transport direction, and wherein the pallets and/or the items stacked thereon are arranged at a small distance with respect to one another, in particular partially touching one another, and said system comprises at least one plant for the individual packaging in each case of at least the items located on the pallets.

### BACKGROUND OF THE INVENTION

In the paper industry, there are customarily a plurality of supply lines which are arranged running next to one another in parallel. In the supply line, a paper web, which can have a width of up to 10 m, is unwound from a reel. The paper web is cut into individual sheets of paper in a sheet cutter which has blades oriented both longitudinally and transversely with respect to the transport direction. A number of pallets arranged next to one another, the number being adapted to the overall width of the cut web of paper, is erected behind the sheet cutter, as seen in the transport direction, with adjacent pallets touching. The cut sheets of paper are deposited onto said pallets. If a group of pallets has reached the maximum stack height, the stacks of items, i.e. the pallets arranged next to one another with the stacks of paper or cardboard located thereon, have to be transported away.

In practice, the sheets of a group partially overlap. This is the case in particular if, for example, the stack of paper or cardboard is arranged offset somewhat with respect to the pallet thereof. If the stacks of items of a group are intended to be transported away individually, it is necessary to begin in this respect with the transporting away of the respectively outer pallet of a group. This has been undertaken to date manually or with a lifting device. Such a transporting away is costly in terms of time, awkward and also prone to malfunction.

Converters are also known which, in the region of the surface thereof, firstly have rollers for transporting an item in the one direction and secondly have chain strands which permit transport in a 90° direction with respect to the rollers. For example, the rollers are raised or lowered depending on the desired transport direction. Since, however, in particular in the paper industry, pallets having just four lower-side corner blocks are used, transporting away by means of converters is scarcely possible since the supporting effect between the corner blocks is missing for transport by means of the rollers. Furthermore, because of the fixed distances between the rollers and the conveyor chains, converters are generally defined for one specific type of pallet and one specific pallet size.

### SUMMARY OF THE INVENTION

It is the object of the invention to avoid the abovementioned disadvantages and to specify a system which, even in the event of changing pallet formats and/or pallet dimensions, permits rapid and simple transporting of the stacks of items away from the supply lines for the purpose of subsequent, individual packaging.

This object is achieved in that a transport device is provided which is movable laterally into positions which are in each case adjacent to the end regions of the supply lines for taking delivery of the entire group from said supply line, and in that furthermore a transfer station is provided which comprises a supply device, a hoisting device and a removal device, wherein the transport device is furthermore movable laterally with respect to the supply device or with respect to an interconnected, further transport medium for transferring the entire group to the supply device or for transferring same to the further transport medium, and wherein the hoisting device is designed for transferring either a stack of items of one group or simultaneously a plurality of stacks of items, in particular all stacks of items, of a group from the supply device to the removal device, and wherein, for the transferring of an entire group, the removal device comprises two conveyor belts which are drivable independently of each other and are connected one behind the other in a line and which are controllable independently of each other in order to separate the pallets, i.e. the stacks of items.

The system according to the invention permits rapid transporting away since the entire group of stacks of items of a supply line is accepted simultaneously and replaced by empty pallets. The pallet formats and/or pallet dimensions can vary between the supply lines. The group of one supply line can thus consist, for example, of four stacks of items, while the group of the adjacent supply line consists of five stacks of items, or the stacks of items have a different pallet format and/or a different pallet size.

The group of stacks of items accepted by the transport device to be transferred directly to the supply device. Alternatively, a further transport medium, such as, for example, a conveyor belt, the movement direction of which is designed to be aligned with the transport direction of the supply lines, to be provided between the transport device and the supply device.

A small distance between adjacent pallets and/or items stacked thereon is understood as meaning a distance of less than 10 cm, in particular less than 5 cm. A movement laterally is understood as meaning a direction of movement which is oriented parallel to the arrangement of the group of pallets to be transferred and therefore orthogonally with respect to the transport direction within the supply line.

A conveyor belt is understood as meaning all conveyor devices and therefore, for example, also roller or chain conveyors. In the downstream plant for the individual packaging in each case by means of a film, at least the items located on the pallet are packaged. Of course, it is also possible that the packaging also comprises at least the sides of the pallet.

The transport device here can be designed either as a shuttle carriage with a conveyor belt, the direction of movement of which is designed to be aligned with the transport direction of the supply lines, or as a conveyor belt or as a crane. If the transport device is designed as a shuttle carriage, the latter is mounted movably, for example, on rails. In the region of the upper side, the shuttle carriage has a conveyor belt which is drivable orthogonally with respect to the direction of movement of the shuttle carriage. The group can therefore be accepted in the region of the end of the supply line and moved on the shuttle carriage in the direction of the transport direction of the supply line.

The further transport medium and/or the supply device and/or the removal device and/or the end region at least of one supply line can be designed in each case as a conveyor belt.

In particular for transferring an entire group, it is appropriate if the first conveyor belt of the removal device, as seen in the general transport direction, is designed as a turntable conveyor belt or as a rotary slide conveyor. In comparison to a conveyor belt, a turntable conveyor belt is mounted rotatably in relation to the underlying surface. An entire group or an individual stack of items can therefore be rotated. If rotation is required, the turntable conveyor belt is first of all rotated in an orientation which is 90° with respect to the intended transport direction, and the pallet or the group is deposited onto the turntable conveyor belt. The turntable conveyor belt is then rotated again by 90° and the entire group or else the individual stack of items is transported further in the transport direction.

It is also possible for the second conveyor belt of the removal device, as seen in the general transport direction, to be designed as a turntable conveyor belt.

A crane which is movable, in particular on rails, can be provided as the hoisting device.

The hoisting device can have at least one fork carrier with at least two prongs which can be brought into engagement with the pallet(s) of the stacks of items that is (are) to be raised.

The hoisting device can have two fork carriers which are arranged opposite each other and are movable towards each other, wherein each fork carrier has a number of prongs adapted to the number of pallets of the stacks of items that are to be raised, and wherein the prongs of the fork carriers engage in the pallets from both sides. It is appropriate, for example, when raising five stacks of items, for a total of ten prongs to be provided per fork carrier, said prongs then engaging in the corresponding intermediate spaces between the corner blocks of the pallets.

The hoisting device additionally can have a device for rotating a raised stack of items of one group or for the joint rotating of the entirety consisting of a plurality of, in particular all, raised stacks of items of a group. Such a device can be integrated in the hoisting device so that rotation of a stack of items or of the group is therefore also possible during the hoisting operation.

The hoisting device can have a device which, upon insertion of at least one prong of a fork carrier, detects a collision with a resistance and, in particular, is connected to a control device which is designed to prevent further insertion of the colliding prong or of all of the prongs and preferably to initiate a reverse movement, for example of the colliding prong. If a resistance is detected since, for example, a prong strikes against a corner block as the prong is inserted into a pallet, it is possible, for example, for a fault message to be issued. Of course, the further insertion operation of the prongs can also be interrupted. It is also conceivable for the relevant prong to be folded upward or away.

The hoisting device can have a detection device which, before or upon insertion of at least one prong of a fork carrier, detects an imminent collision, by means of a measuring device operating contactlessly, and in particular is connected to a control device which is designed to prevent insertion or further insertion of the colliding prong or of all of the prongs and preferably to initiate a reverse movement of an already partially inserted prong which threatens to collide. The measuring device can be, for example, an optical sensing device, an ultrasonic unit, a laser or the like.

At least one prong of a fork carrier can be designed to be shiftable relative to the fork carrier counter to the insertion direction counter to a force acting in the insertion direction, in particular counter to a spring force, in the event of a collision, for example with a corner block on the lower side of the pallet, counter to this force, in particular counter to this spring force. While the fork carrier is therefore shiftable further in the insertion direction, the position of each colliding prong with respect to the pallet remains unchanged while the other prongs can be moved further into the clearances in the pallet.

It is appropriate if the position of at least one prong is changeable horizontally for adaptation to the pallet to be raised. The changing can be undertaken manually. However, changing by means of a drive is also conceivable. Of course, it is also possible for the drive to be connected to a control device, and therefore, when an imminent collision is detected by means of a measuring device operating contactlessly, the position of the prong which threatens to collide is changed. Therefore, for example, a fork carrier which has a multiplicity of prongs can be adapted to types of pallet of any configuration and pallet dimensions.

The invention also relates to a method for transporting away stacks of items which consist of pallets with items stacked thereon, in particular with stacks of paper or cardboard stacked thereon, from at least two supply lines for the purpose of subsequent, individual packaging of the stacks of items, wherein the supply lines are designed so as to run in a transport direction and the end regions of which are arranged laterally next to each other, and wherein each supply line, as seen in the transport direction, ends with groups of stacks of items, wherein each group consists of at least two stacks of items which are arranged next to each other in the end region transversely with respect to the transport direction, and wherein the pallets and/or the items stacked thereon are arranged at a small distance with respect to one another, in particular partially touching one another.

In the paper industry, there are customarily a plurality of supply lines which are arranged running next to one another in parallel. In the supply line, a paper web, which can have a width of up to 10 m, is unwound from a reel. The paper web is cut into individual sheets of paper in a sheet cutter which has blades oriented both longitudinally and transversely with respect to the transport direction. A number of pallets arranged next to one another, the number being adapted to the overall width of the cut web of paper, is erected behind the sheet cutter, as seen in the transport direction, with adjacent pallets touching. The cut sheets of paper are deposited onto said pallets. If a group of pallets has reached the maximum stack height, the stacks of items, i.e. the pallets arranged next to one another with the stacks of paper or cardboard located thereon, have to be transported away.

In practice, the sheets of a group partially overlap. This is the case in particular if, for example, the stack of paper or cardboard is arranged offset somewhat with respect to the pallet thereof. If the stacks of items of a group are intended to be transported away individually, it is necessary to begin in this respect with the transporting away of the respectively outer pallet of a group. This has been undertaken to date manually or with a lifting device. Such a transporting away is costly in terms of time, awkward and also prone to malfunction.

Converters are also known which, in the region of the surface thereof, firstly have rollers for transporting an item in the one direction and secondly have chain strands which permit transport in a 90° direction with respect to the rollers. For example, the rollers are raised or lowered depending on the desired transport direction. Since, however, in particular in the paper industry, pallets having just four lower-side corner blocks are used, transporting away by means of converters is scarcely possible since the supporting effect between the corner blocks is missing for transport by means of the rollers. Furthermore, because of the fixed distances between the rollers and the conveyor chains, converters are generally defined for one specific type of pallet and one specific pallet size.

It is the object of the invention to avoid the abovementioned disadvantages and to specify a method which, even in the case of changing pallet formats and/or pallet dimensions, permits rapid and simple transporting of the stacks of items away from the supply lines for the purpose of subsequent, individual packaging.

This object is achieved in that a transport device is provided which is moved laterally into positions which are in each case adjacent to the end regions of the supply lines for taking delivery of the entire group from said supply line, and takes delivery there of the entire group from said supply line, and in that furthermore a transfer station is provided which comprises a supply device, a hoisting device and a removal device, wherein the transport device furthermore is moved laterally with respect to the supply device or with respect to an interconnected, further transport medium for transferring the entire group to the supply device or for transferring same to the further transport medium, and the accepted group is transported further with respect to the supply device of the transfer station or with respect to the further transport medium, wherein the hoisting device subsequently transfers either a stack of items of one group or simultaneously a plurality of stacks of items, in particular all stacks of items, of a group from the supply device to the removal device, and wherein, for the transferring of an entire group, the removal device comprises two conveyor belts which are drivable independently of each other and are connected one behind the other in a line, and therefore the stacks of items of the group are separated by the entire group being transported further, by driving of the two conveyor belts connected one behind the other, until the first stack of items, as seen in the general transport direction, has been accepted by the second conveyor belt and then the speed of the first conveyor belt, as seen in the general transport direction, is reduced, in particular to a standstill.

Either a shuttle carriage with a conveyor belt, the direction of movement of which is designed to be aligned with the transport direction of the supply lines, or a conveyor belt or a crane can be used here as the transport device.

A conveyor belt can be used in each case as the further transport medium and/or as the supply device and/or as the removal device and/or as the end region at least of one supply line.

In particular for the transfer of an entire group, it is appropriate if a turntable conveyor belt is used as the first conveyor belt of the removal device, as seen in the general transport direction.

It is also possible that a turntable conveyor belt is used as the second conveyor belt of the removal device, as seen in the general transport direction.

Use can be made here of a hoisting device which has a device which, upon insertion of at least one prong of a fork carrier, detects a collision with a resistance, and a control device connected to the device prevents further insertion of the colliding prong or of all of the prongs and preferably initiates a reverse movement. It is possible here for only the colliding prong or for all of the prongs or else the entire fork carrier to be moved back.

Use can be made here of a hoisting device which has a detection device which, before or upon insertion of at least one prong of a fork carrier, detects an imminent collision, by means of a measuring device operating contactlessly, and a control device connected to the detection device prevents insertion or further insertion of the colliding prong or of all of the prongs and preferably initiates a reverse movement of an already partially inserted prong which threatens to collide. The measuring device can be, for example, an optical sensing device, an ultrasonic unit, a laser or the like.

### BRIEF DESCRIPTION OF THE FIGURES

Exemplary embodiments of the invention that are illustrated in the drawings are explained below. In the drawings:

FIG. 1 shows a first exemplary embodiment of the invention, and

FIG. 2 shows a second exemplary embodiment of the invention.

### DETAILED DESCRIPTION OF THE PREFERRED EMBODIMENT(S)

In all of the figures, corresponding reference numbers are used for identical or similar components.

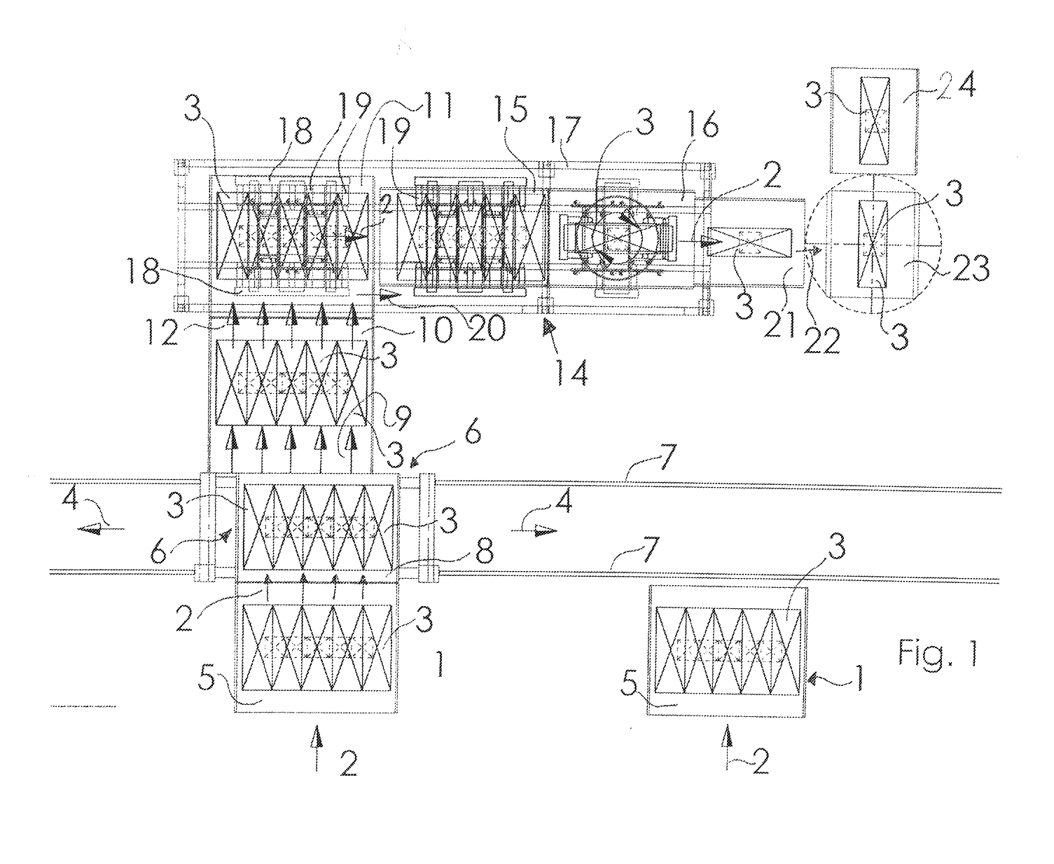

FIG. 1 illustrates an exemplary embodiment which has a total of two supply lines 1. A paper web which can have a width of up to 10 m is unwound from a reel in each of the supply lines 1 (not illustrated specifically). The paper web is cut into individual sheets of paper in a sheet cutter which has blades oriented both longitudinally and transversely with respect to the transport direction. A number of pallets arranged next to one another, the number being adapted to the overall width of the cut paper web, is erected behind the sheet cutter, as seen in the transport direction (arrow 2), with adjacent pallets touching.

Of the respective supply line 1, only those regions in which the pallets which are already stacked with stacks of paper or cardboard, i.e. the stacks of items 3, are arranged are illustrated. In the exemplary embodiment illustrated, each group comprises a total of five stacks of items 3, which are in each case indicated by a cross. The small boxes containing the cross are intended to indicate stacks of items 3 of the smallest possible dimensions and the larger rectangular boxes containing the cross are intended to indicate the stacks of items 3 with the largest possible dimensions.

A movement laterally is understood as meaning a direction of movement 4 which is oriented parallel to the arrangement of the group of stacks of items 3 that is to be transferred and therefore orthogonally to the transport direction 2 within the supply line 1.

A transport device 6 is provided in the respective end region 5 of the two supply lines 1, said transport device 6 being movable laterally with respect to the supply line 1, in which the group of the stacks of items 3 are taken delivery of, in the direction of the arrow 4 for taking delivery of the entire group from said supply line 1. In the exemplary embodiment illustrated, this transport device 6 is a shuttle carriage which is movable on rails 7.

In the region of the upper side, the shuttle carriage has a conveyor belt 8 which permits transport from the left supply line 1 (in the exemplary embodiment illustrated) in the direction of the arrows 9. In the exemplary embodiment illustrated, the transport device 6 transfers the entire group of stacks of items 3 onto an interconnected, further transport medium 10 which, in turn, is designed as a conveyor belt.

The further transport medium 10 in turn transfers the entire group to a supply device 11 of a transfer station. This is possible since the supply device 11, for its part, consists of a conveyor belt which permits a movement in the direction of the arrows 12.

The entire group is thereby transported in an unchanged direction from the end region 5 of the supply line 1 via the transport device 6 and via the further transport medium 10 to the supply device 11 of the transfer station. The general transport direction of the group therefore remains unchanged from the end region 5 of the supply line 1 to the supply device 11.

In addition to the supply device 11, the transfer station comprises a hoisting device 13 and, furthermore, a removal device 14. The removal device 14 comprises two conveyor belts 15, 16 which are drivable independently of each other and are connected one behind the other in a line. In the exemplary embodiment illustrated, the hoisting device 13 consists of a crane which is movable on rails 17. The hoisting device 13 has two fork carriers 18 which are arranged opposite each other and are movable towards each other, wherein each fork carrier 18 has a number of prongs 19 matched to the number of pallets of the stacks of items 3 that are to be raised, and wherein the prongs 19 of the fork carriers 18 engage in the pallets from both sides.

In the exemplary embodiment illustrated in FIG. 1, each fork carrier 18 has seven prongs 19 which can be brought into engagement with the pallets of the group that are to be raised. After the engagement, the entire group of stacks of items 3 is raised, and the hoisting device 13 is moved in the direction of the arrow 20.

The group of stacks of items 3 is then deposited onto the first conveyor belt 15, as seen in the general transport direction 2. Since the conveyor belts 15, 16 of the removal device 14 are drivable independently of each other and are connected one behind the other in a line, the group can be separated by the entire group being transported further, by driving of the two conveyor belts 15, 16 connected one behind the other, until the first stack of items 3, as seen in the general transport direction 2, has been accepted by the second conveyor belt 16, as seen in the general transport direction 2. The speed of the first conveyor belt 15 is then reduced, in particular to a standstill, for the separation and is subsequently increased again.

The second conveyor belt 15 is designed in FIG. 1 as a turntable conveyor belt, and therefore the stacks of items 3 that are now separated can also be rotated if required. Said conveyor belt comprises prongs (not illustrated) which can be brought into engagement with the pallets of the group. The prongs are raised, and the stacks of items 3 are then jointly rotated. After the rotation, the pallet is lowered again and the prongs are removed. The two conveyor belts 15, 16 of the removal device 14 permit further transport in the direction of the general transport direction 2 which has changed by 90° in the region of the supply device 11.

In the exemplary embodiment illustrated in FIG. 1, the second conveyor belt 16 is adjoined by yet another conveyor belt 21 which permits further transport in the direction of the arrow 22. Said further conveyor belt is adjoined by a rotary slide conveyor 23 which permits a change in the transport direction, and therefore the stack of items 3 can be transferred to a further conveyor belt 24. For the rotation, the rotary slide conveyor 23 is shifted somewhat, and therefore the rotational movement can subsequently take place. The rotary slide conveyor 23 is then shifted back again into the original position thereof.

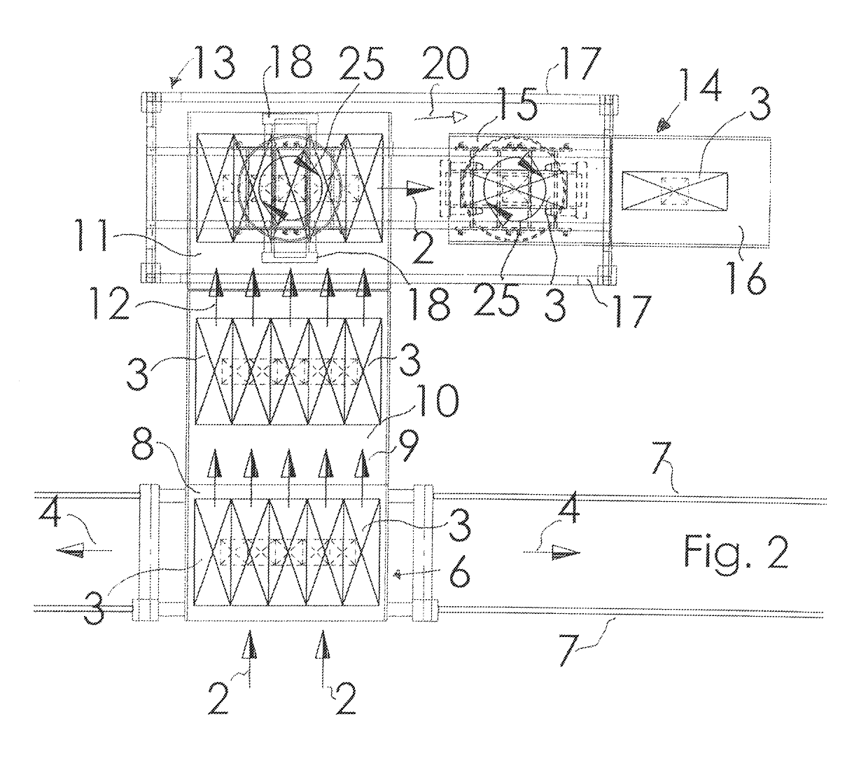

FIG. 2 illustrates an alternative configuration such that here the hoisting device 13 raises just one stack of items 3 from the group in the supply device 11 and, after moving, deposits same on the first conveyor belt 15 of the removal device 14. In the exemplary embodiment illustrated, the hoisting device 13 has a device for rotating the raised stack of items 3.

As indicated by the arrows 25, when a sufficient lateral distance from the stacks of items 3 of the group that are still in the supply device 11 is reached, the stack of items 3 which has already been raised can be rotated such that the latter has a different orientation when deposited on the first conveyor belt 15 of the removal device 14. After the depositing, the two fork carriers 18 with the two prongs 19 in each case are released again by moving apart and are moved back into the region of the supply device 11 in order to receive the next stack of items 3 from the group.

Of course, instead of the device for rotation in the hoisting device 13, it is also possible, for example, for the first conveyor belt 15 of the removal device 14 to be designed as a turntable conveyor belt.

The further transport medium 10 is not absolutely necessary. Said transport medium facilitates the transporting away, for example in the event of a change of film, since the transporting away of the separated stacks of items 3 can then be interrupted. In this case, a group can be temporarily parked on the further transport medium 10.

FIG. 2 does not illustrate either the supply lines 1 mounted upstream or the components adjoining the two conveyor belts 15, 16 of the removal device 14. The plant which is in each case connected downstream and in which at least the items located on the pallet are packaged by means of a film is also not illustrated in the two figures.

The first conveyor belt 15 illustrated in FIG. 2 can also be designed as a rotary slide conveyor. Since, in the case of such a configuration, a stack of items 3 can be rotated on the conveyor belt 15, which is designed as a rotary slide conveyor, and therefore the orientation of said stack of items 3 can be changed, a device for rotating in the hoisting device 13 is not required.

If a further transport medium 10 is not required, the transport device 6 is arranged in the vicinity of the supply device 11 such that an entire group can be transported in an unchanged direction from the end region 5 of the supply line 1 via the transport device 6 to the supply device 11 of the transfer station.

I claim:

1. System for transporting away stacks of items (3) which consist of pallets with items stacked thereon, in particular with stacks of paper or cardboard stacked thereon, wherein the system comprises at least two supply lines (1) for the stacks of items (3), which are designed so as to run in a transport direction (2) and the end regions (5) of which are arranged laterally next to each other, and wherein each supply line (1), as seen in the transport direction (2), ends with groups of stacks of items (3), wherein each group consists of at least two stacks of items (3) which are arranged next to one another in the end region (5) transversely with respect to the transport direction (2), and wherein the pallets and/or the items stacked thereon are arranged at a small distance with respect to one another, in particular partially touching one another, and said system comprises at least one plant for the individual packaging in each case of at least the items located on the pallets, characterized in that a transport device (6) is provided which is movable laterally into positions which are in each case adjacent to the end regions (5) of the supply lines (1) for taking delivery of the entire group from said supply line (1), and in that furthermore a transfer station is provided which comprises a supply device (11), a hoisting device (13) and a removal device (14), wherein the transport device (6) is furthermore movable laterally with respect to the supply device (11) or with respect to an interconnected, further transport medium (10) for transferring the entire group to the supply device (11) or for transferring same to the further transport medium (10), and wherein the hoisting device (13) is designed for transferring either a stack of items (3) of one group or simultaneously a plurality of stacks of items (3), in particular all stacks of items, of a group from the supply device (11) to the removal device (14), and wherein, for the transferring of an entire group, the removal device (14) comprises two conveyor belts (15, 16) which are drivable independently of each other and are connected one behind the other in a line and which are controllable independently of each other in order to separate the pallets.

2. System according to claim 1, characterized in that the transport device (6) is designed either as a shuttle carriage with a conveyor belt, the direction of movement (4) of which is designed to be aligned with the transport direction (2) of the supply lines (1), or else as a conveyor belt or as a crane.

3. System according to claim 1, characterized in that the further transport medium (10) and/or the supply device (11) and/or the removal device (14) and/or the end region (5) at least of one supply line (1) are (is) designed in each case as a conveyor belt.

4. System according to claim 1, characterized in that, in particular for transferring an entire group, the first conveyor belt (15) of the removal device (14), as seen in the general transport direction (2), is designed as a turntable conveyor belt or rotary slide conveyor.

5. System according to claim 1, characterized in that the second conveyor belt (16) of the removal device (14), as seen in the general transport direction (2), is designed as a turntable conveyor belt.

6. System according to claim 1, characterized in that a crane which is movable, in particular on rails (17), is provided as the hoisting device (13).

7. System according to claim 1, characterized in that the hoisting device (13) has at least one fork carrier (18) with at least two prongs (19) which can be brought into engagement with the pallet(s) of the stacks of items (3) that is (are) to be raised.

8. System according to claim 1, characterized in that the hoisting device (13) has two fork carriers (18) which are arranged opposite each other and are movable towards each other, wherein each fork carrier (18) has a number of the prongs (19) adapted to the number of pallets of the stacks of items (3) that are to be raised, and wherein the prongs (19) of the fork carriers (18) engage in the pallets from both sides.

9. System according to claim 1, characterized in that the hoisting device (13) additionally has a device for rotating a raised stack of items (3) of one group or for the joint rotating of the entirety consisting of a plurality of, in particular all, raised stacks of items (3) of a group.

10. System according to claim 7, characterized in that the hoisting device (13) has a device which, upon insertion of at least one prong (19) of a fork carrier (18), detects a collision with a resistance and, in particular, is connected to a control device which is designed to prevent further insertion of the colliding prong (19) or of all of the prongs (19) and preferably to initiate a reverse movement.

11. System according to claim 7, characterized in that the hoisting device (13) has a detection device which, before or upon insertion of at least one prong (19) of a fork carrier (18), detects an imminent collision, by means of a measuring device operating contactlessly, and in particular is connected to a control device which is designed to prevent insertion or further insertion of the colliding prong or of all of the prongs and preferably to initiate a reverse movement of an already partially inserted prong which threatens to collide.

12. System according to claim 7, characterized in that at least one prong (19) of a fork carrier (18) is designed to be shiftable relative to the fork carrier (18) counter to the insertion direction counter to a force acting in the insertion direction, in particular counter to a spring force, in the event of a collision counter to said force, in particular spring force.

13. System according to claim 7, characterized in that the position of at least one prong (19) is changeable horizontally for adaptation to the pallet to be raised.

14. Method for transporting away stacks of items (3) which consist of pallets with items stacked thereon, in particular with stacks of paper or cardboard stacked thereon, from at least two supply lines (1) for the purpose of subsequent, individual packaging of the stacks of items (3), wherein the supply lines (1) are designed so as to run in a transport direction (2) and the end regions (5) of which are arranged laterally next to each other, and wherein each supply line (1), as seen in the transport direction (2), ends with groups of stacks of items (3), wherein each group consists of at least two stacks of items (3) which are arranged next to each other in the end region (5) transversely with respect to the transport direction (2), and wherein the pallets and/or the items stacked thereon are arranged at a small distance with respect to one another, in particular partially touching one another, in particular for use in a system according to claim 1, characterized in that a transport device (6) is provided which is moved laterally into positions which are in each case adjacent to the end regions (5) of the supply lines (1) for taking delivery of the entire group from said supply line (1), and takes delivery there of the entire group from said supply line (1), and in that furthermore a transfer station is provided which comprises a supply device (11), a hoisting device (13) and a removal device (14), wherein the transport device (6) furthermore is moved laterally with respect to the supply device (11) or with respect to an interconnected, further transport medium (10) for transferring the entire group to the supply device (11) or for transferring same to the further transport medium (10), and the accepted group is transported further with respect to the supply device (11) of the transfer station or with respect to the further transport medium (10), wherein the hoisting device (13) subsequently transfers either a stack of items (3) of one group or simultaneously a plurality of stacks of items (3), in particular all stacks of items, of a group from the supply device (11) to the removal device (14), and wherein, for the transferring of an entire group, the removal device (14) comprises two conveyor belts (15, 16) which are drivable independently of each other and are connected one behind the other in a line, and therefore the stacks of items (3) of the group are separated by the entire group being transported further, by driving of the two conveyor belts (15, 16) connected one behind the other, until the first stack of items (3) has been accepted by the second conveyor belt (16) and then the speed of the first conveyor belt (15) is reduced, in particular to a standstill.

15. Method according to claim 14, characterized in that either a shuttle carriage with a conveyor belt, the direction of movement (4) of which is designed to be aligned with the transport direction (2) of the supply lines (1), or a conveyor belt or a crane is used as the transport device (6).

16. Method according to claim 14, characterized in that a conveyor belt is used in each case as the further transport medium (10) and/or as the supply device (11) and/or as the removal device (14) and/or as the end region (5) at least of one supply line (1).

17. Method according to claim 14, characterized in that, in particular for transferring an entire group, a turntable conveyor belt is used as the first conveyor belt (15) of the removal device (14), as seen in the general transport direction (2).

18. Method according to claim 14, characterized in that a turntable conveyor belt is used as the second conveyor belt (16) of the removal device (14), as seen in the general transport direction (2).

19. Method according to claim 14, characterized in that use is made of a hoisting device (13) which has a device which, upon insertion of at least one prong (19) of a fork carrier (18), detects a collision with a resistance, and in that a control device connected to the device prevents further insertion of the colliding prong or of all of the prongs and preferably initiates a reverse movement.

20. Method according to claim 14, characterized in that use is made of a hoisting device (13) which has a detection device which, before or upon insertion of at least one prong (19) of a fork carrier (18), detects an imminent collision, by means of a measuring device operating contactlessly, and in that a control device connected to the detection device prevents insertion or further insertion of the colliding prong (19) or of all of the prongs (19) and preferably initiates a reverse movement of an already partially inserted prong (19) which threatens to collide.
